(19) United States
(12) Patent Application Publication
(10) Pub. No.: US 2019/0070883 A1
(43) Pub. Date: Mar. 7, 2019

(54) THREE-DIMENSIONAL SPACE FABRIC MAT PRODUCTION APPARATUS, AND MULTIPURPOSE MAT AND MAT PRODUCTION METHOD, USING SAME

(71) Applicant: Soo Chang LEE, Daegu (KR)

(72) Inventor: Soo Chang LEE, Daegu (KR)

(21) Appl. No.: 16/083,480

(22) PCT Filed: Mar. 8, 2017
(86) PCT No.: PCT/KR2017/002510

§ 371 Date: Sep. 7, 2018

(30) Foreign Application Priority Data
Mar. 9, 2016 (KR) 10-2016-0028388

(51) Int. Cl. B41M 5/382; A47G 27/02

(52) U.S. Cl. CPC B41M 5/3825; A47D 15/001; A47G 27/0212

(57) ABSTRACT

The present invention relates to a mat production apparatus for producing a multifunctional mat. The mat production apparatus includes: a transfer printing device including a guide unit configured to introduce a multifunctional mat and transfer paper, a first heating panel configured to include an aluminum heater panel so that transfer printing can be performed, a first manifold configured to distribute heat, a transfer means disposed below the first manifold and configured to perform transfer printing on the multifunctional mat through thermal bonding without pressure, and a first elevation means configured to selectively elevate and lower the transfer means; and a processing device including a mat seating part configured such that the transfer-printed multifunctional mat is seated thereon and a processing panel disposed above the mat seating part and configured to perform thermal bonding so that folding grooves and edges can be formed on the multifunctional mat.

### TECHNICAL FIELD

The present invention relates to a mat production apparatus, and a multipurpose mat using the same. More specifically, the present invention relates to a mat production apparatus capable of easily producing a multipurpose mat including an upper mat made of three-dimensional space fabric and a lower mat configured such that functional members including cypress wood, germanium, and red clay are contained therein, and a multipurpose mat using the same.

### BACKGROUND ART

Generally, mats are installed at the entrances of buildings, such as offices, houses, hotels, etc., or on the floors of the entrances of lobbies. Mat products made of carpet fabric, such as common fabric, tricot, knit, etc., are generally used in living rooms, beds, or the like.

However, recently, with the development of industry and the emergence of a well-being culture, interest in the field of development of functional products regarding living products that come into direct contact with our bodies has been ever increasing.

Recently, attention has been focused on the use of three-dimensional space fabrics that are woven by Double Raschel knitting machines developed in Germany.

In particular, space fabric woven in a three-dimensional structure has an excellent ventilation property because air can be circulated through the space fabric, and thus harmful material, such as house dust, sweat smell, mites, or the like, does not reside therein. Space fabric has an excellent cushioning property and excellent restoring force, and thus it can provide excellent functionality to a living room mat, a bed mat, an infant mat, a hospital bed mat, etc. However, due to the characteristics of the functional space fabric, the functional space fabric is disadvantageous in that the space between a back surface layer and a surface layer is wide, and thus it is difficult to print images, such as patterns, logos, character, and/or the like, having various designs and it is also difficult to weave space fabric according to the purpose thereof. In order to overcome these disadvantages, a separate printing device and a separate processing device (configured to perform thermal bonding by means of a molded design having a desired shape) are fabricated and then the disadvantages are overcome by using the printing device and the processing device.

Furthermore, recently, functional mats in which various materials are used in combination have been developed.

As an example, Korean Patent Application Publication No. 10-2014-0050179 discloses a mat production apparatus for adhering a plurality of precious stones onto a mat, the mat production apparatus including a guide plate provided with a conveying belt configured to convey a mat on which precious stones will be installed, a precious stone introduction means provided above the guide plate and configured to supply a plurality of precious stones to the top surface of the mat, and a pressing means installed at an end of a hydraulic cylinder in order to thermally bond the plurality of precious stones onto the mat supplied from the precious stone introduction means and provided with a pressing plate configured to move vertically.

However, the above-described preceding technical document, the following problems arise.

First, it is necessary to print an image, such as various patterns, characters, logos, and/or the like, on the surface layer of a multifunctional mat. Due to the characteristics of three-dimensional space fabric, the three-dimensional space fabric is knitted by means of a Double Raschel method using pile yarn connecting a surface layer and a back surface layer, and thus the space therebetween is wide, with the result that it is impossible to perform roller transfer printing or screen printing.

When printing is performed on space fabric through convention roller transfer printing, the space fabric is wound around a 230° C. or higher roller and thus melting occurs, cushioning force is eliminated, and washing and drying are impossible after screen printing. Accordingly, when 230° C. or higher heat is applied to a surface layer, on which transfer printing will be performed, without pressure, dye on transfer paper is printed and thus printing is performed, and a pile functioning as a support maintains restoring force and is not deformed. Therefore, there is a need for a separate printing device for overcoming the above-described problem.

Second, Due to the characteristics of three-dimensional space fabric, the three-dimensional space fabric is knitted by means of a Double Raschel method using pile yarn connecting a surface layer and a back surface layer, and thus the space therebetween is wide. In order to produce a multipurpose mat, it is necessary to form the shape of the multipurpose mat by fabricating a separate molded aluminum processing panel and performing thermal bonding by means of a hydraulic press configured to apply considerable pressure. Accordingly, a problem arises in that a work process must be significantly complicated.

### DISCLOSURE

### Technical Problem

In order to overcome the above-described problems, an object of the present invention is to provide a mat production apparatus for producing a multifunctional mat, which can easily produce a multipurpose mat including an upper mat made of space fabric and a lower mat configured such that functional members including cypress wood, germanium, and red clay are contained therein.

Another object of the present invention is to provide a mat production apparatus that can provide a multipurpose mat having the function of preventing decubitus ulcers, etc. when it is used as a bed mat, a hospital mat, an infant mat, a sitting cushion, etc. because harmful material, such as house dust, sweat smell, mites, or the like, does not reside in space fabric capable of providing an excellent ventilation property.

A further object of the present invention is to provide a mat production apparatus that can provide a multipurpose mat capable of being used for various purposes, such as purposes for an inner mat for a tent, a portable sitting cushion, etc., because folding grooves and edges are formed on the multifunctional mat and the multifunctional mat is cut, sewn and finished to be thus convenient for storage and carrying.

Yet another object of the present invention is to provide a mat production apparatus that can provide a multipurpose mat in which a slip prevention means is installed on the back surface thereof and Velcro tape or the like is attached along an edge thereof of the bottom surface thereof, so that when heat insulation is required, the multifunctional mat is covered with heat insulation fabric (carpet fabric, or fabric with bristles) and the heat insulation fabric is selectively attached and detached to and from the multifunctional mat, with the result that washing is facilitated, cost can be cut by half due to use for four seasons, and functionality can be also provided.

### Technical Solution

In order to accomplish the above objects, the present invention includes a printing device capable of performing printing on three-dimensional space fabric and a processing device configured to foam models of multifunctional mats having various purposes through thermal bonding.

The printing device includes a guide unit configured to introduce transfer paper and space fabric, a seating part configured such that the transfer paper and the space fabric are seated thereon for the purpose of printing, an aluminum support configured to enable pressure to be uniformly applied, a first elevation cylinder configured to selectively elevate and lower the aluminum support, a first manifold configured to uniformly distribute heat, and an aluminum first heating panel formed by disposing an electric heater in a heater groove through which the heat is circulated and configured to maintain predetermined temperature. It will be apparent that an electric control device configured to maintain the first heating panel at a predetermined temperature is installed in the printing device.

The processing device includes a press body provided with a cylinder hydraulic device configured such that thermal bonding is performed on printed space fabric by means of a hydraulic press and various attached processing panels, a seating part configured such that thermal bonding is performed on the printed space fabric thereon, a thick flat plate support configured to withstand and uniformly distribute a pressure of about 12 tons, a second manifold configured to uniformly distribute heat, and a processing panel configured to include an aluminum molded design panel that is selectively attached and detached to and from an aluminum second heating panel in which an electric heater is disposed in a heater groove through which the heat is circulated and predetermined temperature is maintained by the electric control device, perform thermal bonding to form models having various purposes and form folding grooves, edges, etc.

Furthermore, a multifunctional mat produced by the mat production apparatus including the printing device and the processing device includes an upper mat simultaneously connected and woven using pile yarn in a space between a plurality of surface fabrics, a lower mat configured such that a member cover configured to enable functional members, including cypress wood, germanium, and red clay, to be contained in separate spaces according to their types is disposed and seams configured to divide the member cover so that the functional members can be separately contained are formed, and an attachment means, such as a zipper, Velcro tape, or the like, disposed on the upper mat or lower mat, and configured to enable selective attachment and detachment according to the purpose of the multifunctional mat.

Moreover, a slip prevention means having predetermined adhesive force is further disposed on the bottom surface of the lower mat in order to prevent the multipurpose mat from slipping, and Velcro tape or the like is attached along an edge of the bottom surface of the multipurpose mat according to the purpose of the multipurpose mat, so that, when heat insulation is required, the multifunctional mat is covered with heat insulation fabric (carpet fabric, or fabric with bristles) and the heat insulation fabric is selectively attached and detached to and from the multifunctional mat, and thus washing is facilitated, cost can be cut by half due to use for four seasons, and functionality can be also provided.

### Advantageous Effects

According to the present invention, an effect is achieved in that the multipurpose mat, including the upper mat made of space fabric and the lower mat configured such that functional members including cypress wood, germanium, and red clay are contained therein, can be easily produced.

Furthermore, according to the present invention, an effect is achieved in that decubitus ulcers, skin allergies, atopic diseases, etc. can be prevented from occurring when the multipurpose mat is used as a bed mat, a hospital mat, an infant mat, a sitting cushion, etc. because harmful material, such as house dust, sweat smell, mites, or the like, does not reside in the space fabric due to the characteristic of the space fabric that provides an excellent ventilation property.

Furthermore, according to the present invention, an effect is achieved in that the multipurpose mat can be used for various purposes, such as purposes for an inner mat for a tent, a portable sitting cushion, etc., because folding grooves and edges are formed on the multifunctional mat and the multifunctional mat is cut, sewn and finished to be thus convenient for storage and carrying.

Moreover, according to the present invention, an effect is achieved in that the slip prevention means is installed on the back surface of the multipurpose mat, so that the multipurpose mat can be prevented from slipping, and the Velcro tape or the like is attached along an edge of the bottom surface of the multipurpose mat according to the purpose of the multipurpose mat, so that when heat insulation is required, the multifunctional mat is covered with heat insulation fabric (carpet fabric, or fabric with bristles) and the heat insulation fabric is selectively attached and detached to and from the multifunctional mat, and thus washing is facilitated, cost can be cut by half due to use for four seasons, and functionality can be also provided.

### DESCRIPTION OF DRAWINGS

FIG. 1 is a view showing the configurations of a printing device and a processing device in a mat production apparatus according to the present invention;

FIG. 2 is an enlarged view showing the configuration of the printing device in the mat production apparatus according to the present invention;

FIG. 3 is an enlarged view showing the configuration of the processing device configured to form folding grooves and edges in the mat production apparatus according to the present invention;

FIG. 4 is a view showing the configurations of various types of aluminum processing panels configured to be attached and detached to and from a heating panel and molded according to their purpose in the mat production apparatus according to the present invention;

FIGS. 5 to 7 are views showing a multifunctional mat produced using the mat production apparatus according to the present invention;

FIGS. 8 to 10 are views showing the use of the multifunctional mat according to the present invention; and

FIG. 11 is a flowchart showing the process of producing a multifunctional mat according to the present invention.

### BEST MODE

A mat production apparatus includes:

a transfer printing device including a guide unit configured to introduce a multifunctional mat and transfer paper, a first heating panel configured to include an aluminum heater panel so that transfer printing of the multifunctional mat can be performed, a first manifold configured to distribute heat provided from the first heating panel, a transfer means disposed below the first manifold and configured to perform transfer printing on the multifunctional mat through thermal bonding without pressure, and a first elevation means configured to selectively elevate and lower the transfer means; and

a processing device including a mat seating part configured such that the multifunctional mat transfer-printed via the printing device is seated thereon and a processing panel having various purposes attached above the mat seating part, and configured to form a shape of the multifunctional mat by forming folding grooves and edges on the multifunctional mat through thermal bonding.

### Mode for Invention

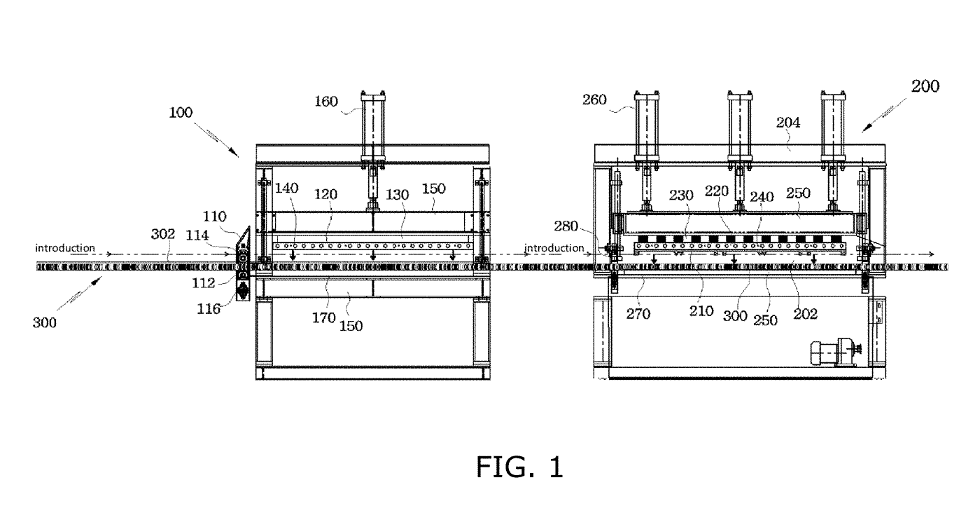

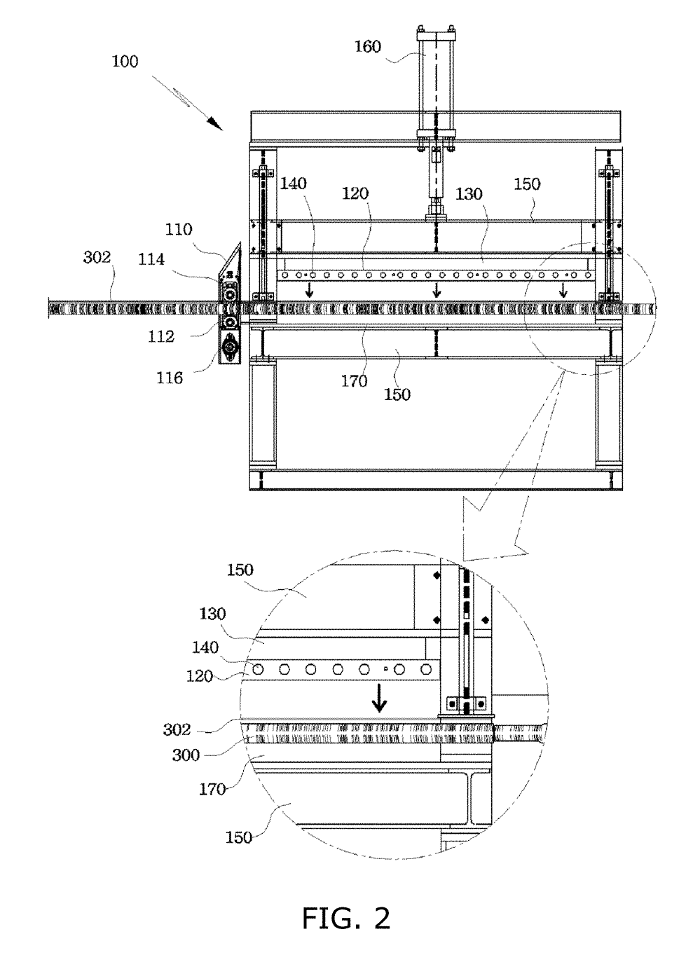

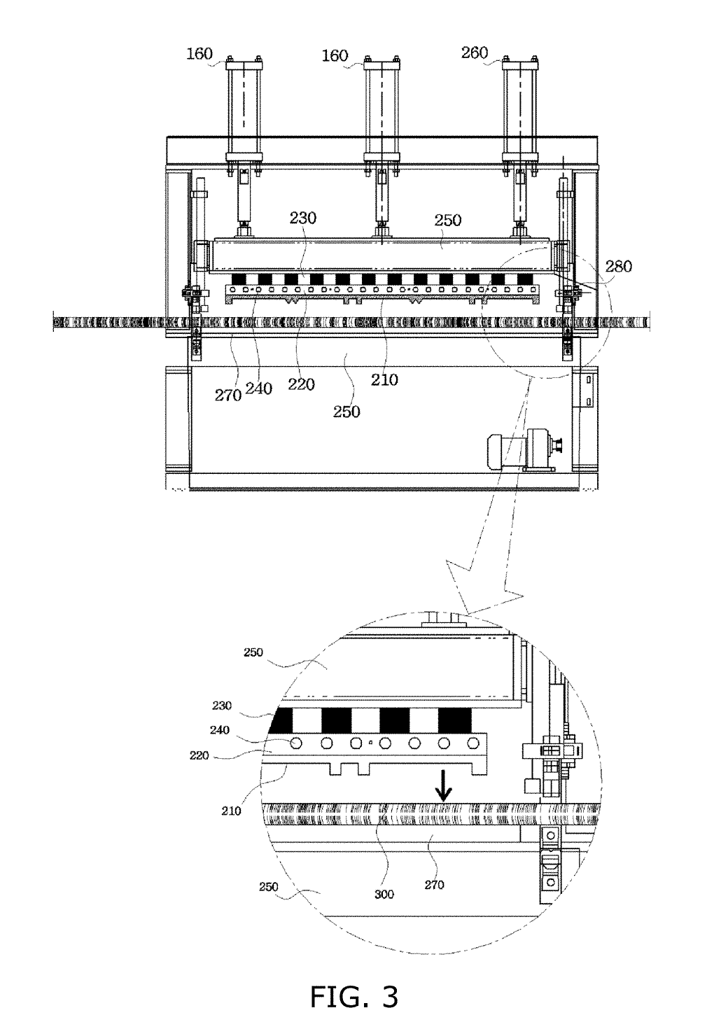

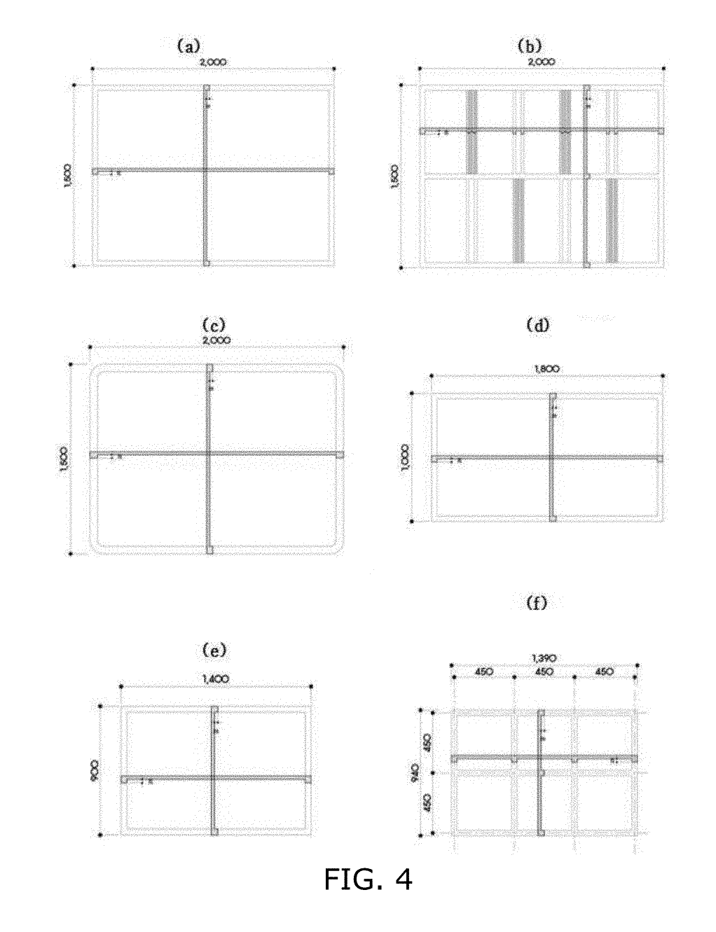

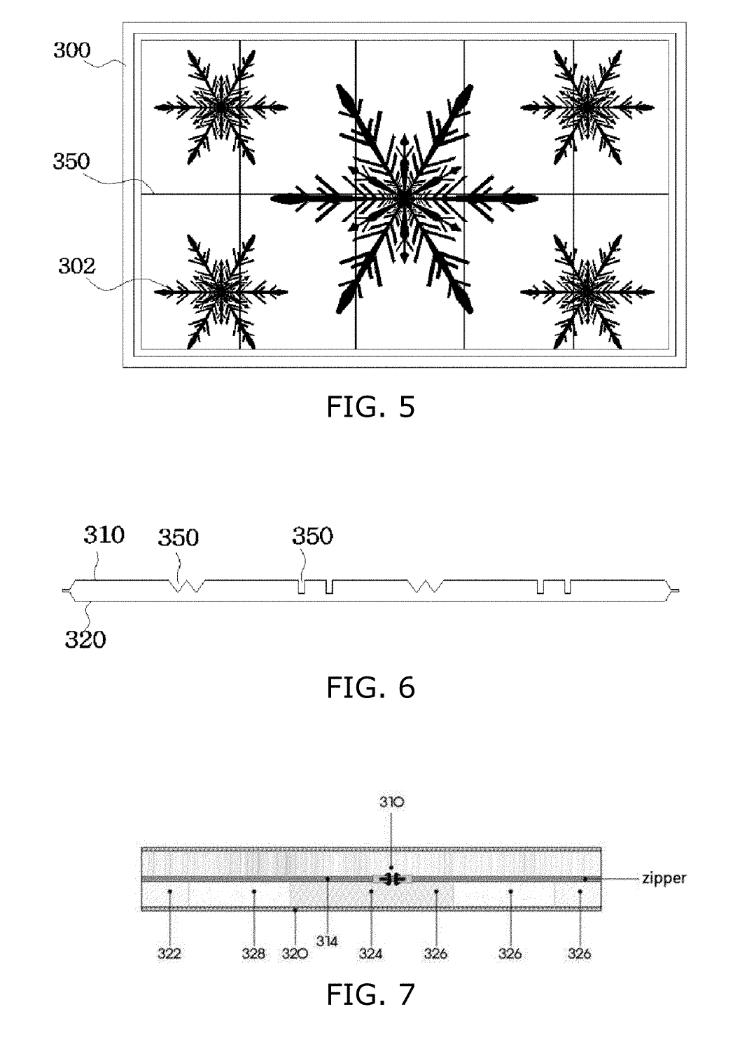

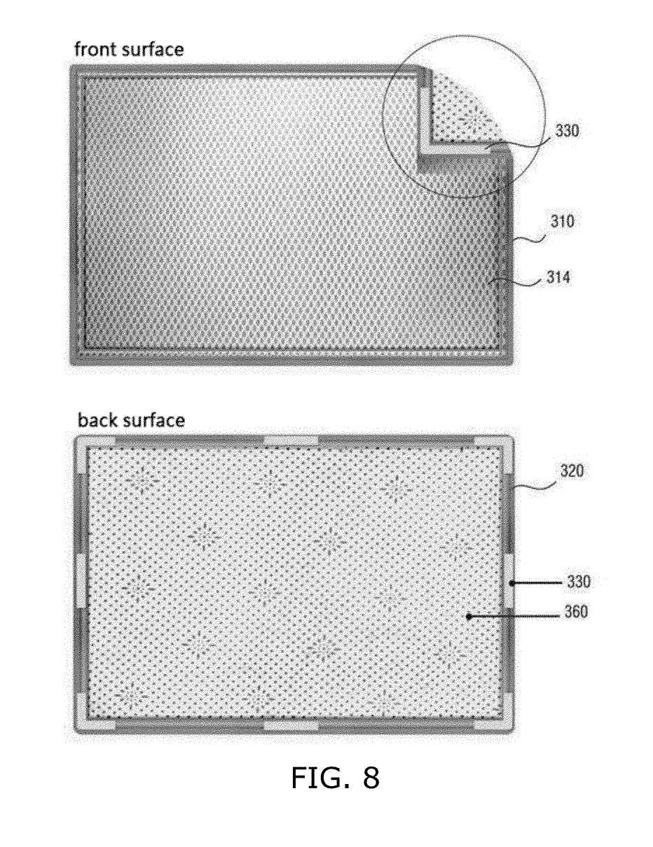

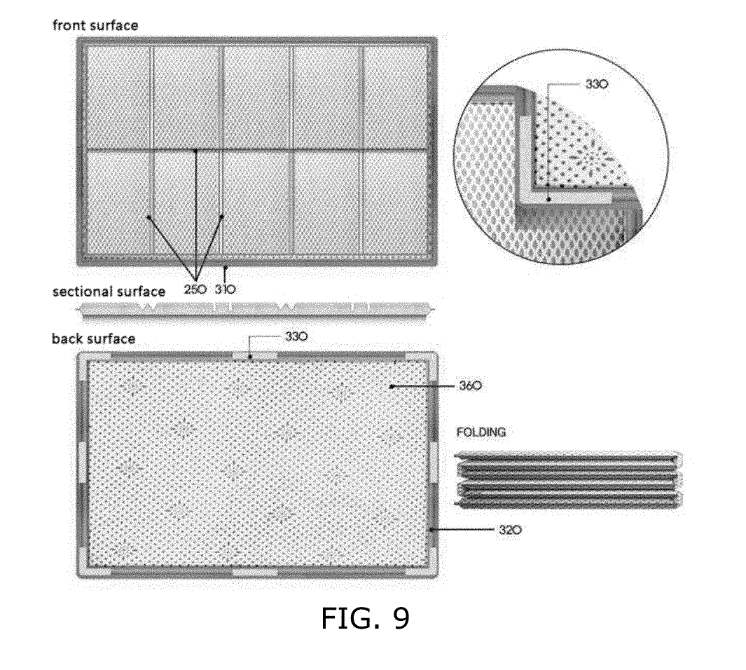

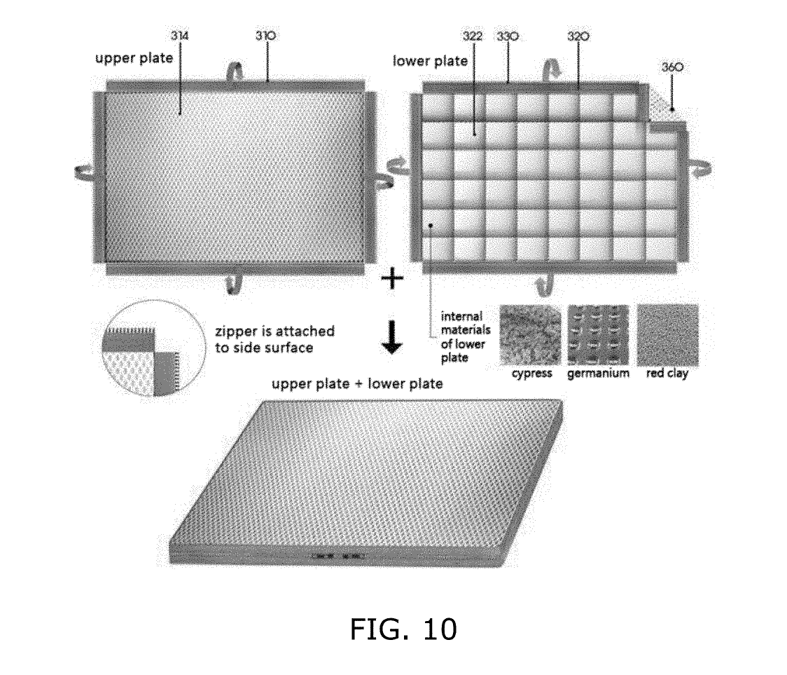

FIG. 1 is a view showing the configuration of a mat production apparatus according to the present invention, FIG. 2 is a view showing the configuration of the printing device of the mat production apparatus according to the present invention, FIG. 3 is a view showing the configuration of the processing device configured to form folding grooves and edges in the mat production apparatus according to the present invention, FIG. 4 is a view showing the configurations of various types of aluminum processing panels configured to be attached and detached to and from a heating panel and molded according to their purpose in the mat production apparatus according to the present invention, FIGS. 5 to 7 are views showing a multifunctional mat produced using the mat production apparatus according to the present invention, and FIGS. 8 to 10 are views showing the use of the multifunctional mat according to the present invention.

As shown in the drawings, the mat production apparatus according to the present invention is intended to produce a multifunctional mat 300 including an upper mat 310 and a lower mat 320, and includes a printing device 100 configured to perform transfer printing on the top surface of the upper mat 310 and a processing device 200 configured to form folding grooves and edges on the multifunctional mat 300 discharged from the printing device 100.

As shown in FIGS. 1 and 2, the printing device 100 is a device configured to form various designs on a surface of the multifunctional mat 300, and includes a guide unit 110 configured to guide the multifunctional mat 300 through the introduction thereof, and a transfer printing unit disposed above a transfer part in order to perform transfer printing on the introduced multifunctional mat 300.

The guide unit 110 is a component configured to guide transfer paper 302 and three-dimensional space fabric, which enable the transfer printing of an image, such as a pattern, a character, a logo, and/or the like, to be performed on the top surface of the upper mat 310 of the multifunctional mat 300, through the introduction thereof.

The guide unit 110 includes a mat introduction roller 112 configured to guide the multifunctional mat 300 through the introduction thereof, a transfer paper roller 114 configured to guide the transfer paper 302 through the introduction thereof, and a roller drive unit 116 configured to control the driving of the rollers.

Meanwhile, first upper and lower support frames 150 configured support the multifunctional mat 300 introduced by the guide unit 110 are disposed in the transfer part of the present invention, thereby enabling uniform transfer printing to be performed.

Furthermore, the transfer printing unit configured to perform transfer printing without pressure while applying predetermined heat to the transfer paper is disposed above the transfer part.

The transfer printing unit includes a first heating panel 120, a first manifold 130, an aluminum electric heater groove 140, and a first elevation means 160.

The first heating panel 120 includes a heater panel having the aluminum electric heater groove 140, and the first manifold 130 uniformly circulates heat provided from the first heating panel 120 while preventing the heat from being lost, thereby enabling transfer printing to be performed.

The first heating panel 120 is formed by disposing an aluminum electric heater in the heater groove 140 through which heat is circulated, and maintains temperature required for transfer printing under the control of an electric control device.

Furthermore, the first elevation means 160 is a component disposed above the first heating panel 120 and configured to perform transfer printing on the multifunctional mat 300 while selectively elevating and lowering the first upper and lower support frames 150 under the control of a transfer control unit.

In this case, a first seating part 170 configured such that the transfer paper 302 and space fabric of the multifunctional mat 300 are seated thereon is disposed on the first upper and lower support frames 150.

In this case, although the first elevation means 160 preferably includes a common cylinder member, the first elevation means 160 is not limited thereto.

In this case, the first elevation means 160 operates such that the first heating panel 120 and the transfer paper 302 simply come into contact with each other in order to prevent pressing force from being transferred to the top surface of the transfer paper 302.

Furthermore, the first elevation means 160 is configured to selectively move up and down, and enables the transfer paper 302 and the surface of the multifunctional mat 300 to be bonded to each other at a predetermined pressure when the transfer paper 302 is introduced.

The processing device 200 is a component configured to form folding grooves and edges on an outer surface of the upper mat 310 of the multifunctional mat 300, transfer-printed via the printing device 100, through thermal bonding, to cut thermally-bonded portions 350 the thickness of which has been reduced, to cover the multifunctional mat 300 with finishing fabric, and to neatly finish the multifunctional mat 300 through sawing, thereby enabling the multifunctional mat 300 to be stored or carried in a folded state.

The processing device 200 configured to form the folding grooves and edges of the multifunctional mat 300 as described above includes a mat seating part 270 configured such that the multifunctional mat 300 on which transfer printing has been performed by the printing device 100 and second upper and lower support frames 250 are disposed thereon, and a processing part disposed above the mat seating part 270 and configured to form thermally-bonded portions 350, including folding grooves and edges, on the multifunctional mat 300.

In this case, the processing device includes a second manifold 230 composed of an aluminum heater panel and configured to receive predetermined heat from the aluminum electric heater groove 240 by means of an electric control device 280, to prevent the heat from being lost, and to uniformly distribute the heat, a second elevation means 260 configured to selectively elevate and lower the processing part, and a processing panel 210 coupled below the second heating panel 220, molded to form folding grooves and edges, and configured to form folding grooves on the multifunctional mat 300.

In this case, the second heating panel 220 includes a heat circulation groove configured such that an electric heater is contained in the aluminum electric heater groove 240 and heat is circulated to keep the temperature of the heat constant and an electric heater disposed in the heat circulation groove, and transfers a temperature ranging from 250 to 300° C. to the processing panel 210.

Furthermore, the second elevation means 260 transfers a pressing force of 12 tons to a groove processing part for two to three minutes, and operates to selectively move up and down so that folding grooves and edges are formed through thermal bonding while processing protrusions formed on the processing panel 210 are pressing the multifunctional mat 300.

It will be apparent that the guide unit 110 may be disposed on the processing device 200 in order to supply the multifunctional mat 300 to the mat seating part 270.

Furthermore, a finishing means configured to finish edge portions on the multifunctional mat 300 may be further disposed on the processing device 200 of the present invention, and a finishing cylinder configured to support the elevating and lowering operations of the finishing means may be further disposed on the processing device 200.

In this case, the finishing means may be formed using a thermal die formed to fit the shape of the multifunctional mat 300, and may be thermally bonded using a plurality of heating rollers. In this case, temperature to be applied is set based on the type, density, and thickness of fiber used in the multifunctional mat 300. In an embodiment of the present invention, thermal bonding is performed at a temperature of 250 to 300° C. for 2 to 3 minutes by using the thermal die.

Meanwhile, the multifunctional mat produced via the above-described mat production apparatus according to the present invention may be used as a living room mat, a foldable camping mat, a bed mat, a mat cover, a hospital mat, an infant mat, a sitting cushion, etc. in various manners according to the purpose thereof.

The above-described multifunctional mat 300 includes the upper mat 310 formed by simultaneously connecting and weaving a plurality of surface fabrics 314 by using pile yarn 312 in a space between the surface fabrics 314, and the lower mat 320 formed by containing functional members 326 including cypress wood, germanium, and red clay.

The upper mat 310 is woven using thick and tough yarn. When fishing guts, highly heat-resistant, tough mono-filaments, or the like are used as the pile yarn 312, a space is formed between the surface fabrics 314 by the pile yarn 312 and also a predetermined thickness is obtained. Also, the surface fabrics 314 are woven in the form of a net having large meshes, thereby being configured to improve ventilation and cushioning properties.

The lower mat 320 includes upper and lower fabrics so that the functional members 326 can be contained in separate spaces according to their types. A member cover 322 configured to form an accommodation portion 328, including a space, between the fabrics is disposed, and seams 324 configured to divide the accommodation portion 328 of the member cover 322 and enable the functional members 326 to be contained are disposed.

An attachment means 330, such as a zipper, Velcro tape, or the like, may be disposed on the multifunctional mat 300 in order to enable selective attachment and detachment according to the purpose of the mat.

Furthermore, a slip prevention means 360 having predetermined adhesive force may be disposed on the bottom surface of the lower mat 320 in order to prevent the multifunctional mat 300 from slipping.

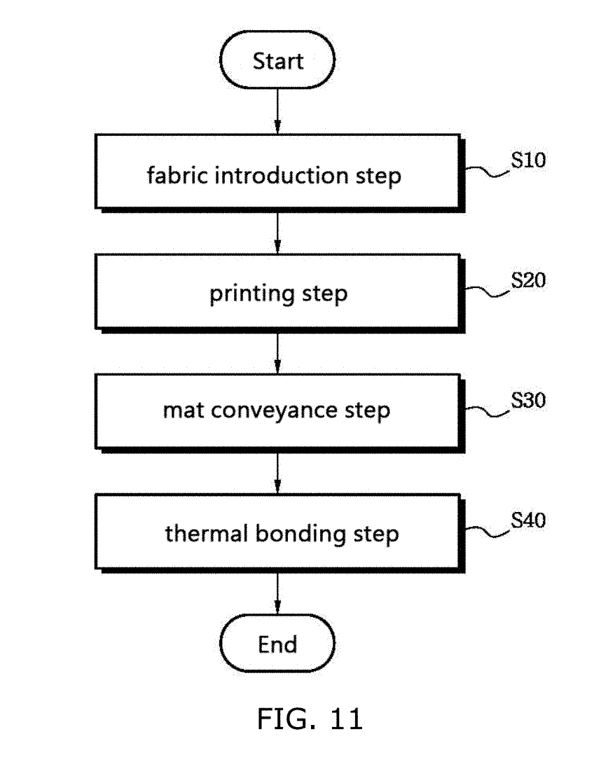

According to the present invention configured as described above, a fabric introduction step S10 of introducing the transfer paper 302 and the space fabric into the printing device 100, as shown in FIG. 11.

Furthermore, after the introduction of the transfer paper 302 and the space fabric into the printing device 100 has been completed, a printing step S20 of performing the transfer printing of an image, such as a pattern, a character, a logo, and/or the like, on the top surface of the multifunctional mat 300 without pressure while applying predetermined heat to the transfer paper.

The printing step S20 includes a first heating step of heating the first heating panel 120 by circulating heat to the first manifold 130 so that transfer printing is performed on the upper mat 310, and a transfer printing step of performing transfer printing on the top surface of the multifunctional mat 300 without pressure by operating the first elevation means 160.

After the printing step S20 has been completed, there is performed a mat conveyance step S30 of conveying the transfer-printed multifunctional mat 300 to the processing device 200 via a means, such as a conveyance roller motor, or the like.

There is performed a thermal bonding step S40 of forming folding grooves and edges by performing thermal bonding on the surface of the multifunctional mat 300, moved via the mat conveyance step S30, at a temperature of 250 to 300° C. for 2 to 3 minutes.

A thermal bonding step S40 includes a second heating step of heating the temperature of the processing panel 210, which is made of an aluminum material and on which the design of folding grooves are formed, to 250 to 300° C., and a thermally-bonded portion formation step of forming the thermally-bonded portions 350, including folding grooves and edges, by lowering the processing panel 210 by means of the second elevation means 260 and pressing the processing panel 210 on the multifunctional mat 300 at a pressing force of 12 tons for 2 to 3 minutes.

The foregoing description is merely an illustrative description of the technical spirit of the present invention. It will be apparent that those having ordinary knowledge in the art to which the present invention pertains may make various modifications and alterations without departing from the essential characteristics of the present invention. Accordingly, the embodiments disclosed in conjunction with the present invention is not intended to limit the technical spirit of the present invention, but is intended to describe the technical spirit of the present invention. Accordingly, the range of the technical spirit of the present invention is not limited by these embodiments. The range of protections of the present invention should be defined based on the following claims, and all technical spirits falling within a range equivalent to the following claims should be interpreted as being included in the range of protections of the present invention.

### INDUSTRIAL APPLICABILITY

According to the present invention, the multipurpose mat, including the upper mat made of space fabric and the lower mat configured such that functional members including cypress wood, germanium, and red clay are contained therein, can be easily produced.

### DESCRIPTION OF REFERENCE SYMBOLS

100: printing device 110; guide unit

120: first heating panel 130: first manifold

140: electric heater groove 150: first upper and lower support frames

160: first elevation means 200: processing device

210: processing panel 230: second manifold

240: aluminum electric heater groove 250: second upper and lower support frame

260: second elevation means 270: mat seating part

280: electric control device 300: multifunctional mat

310: upper mat 320: lower mat

1. A mat production apparatus comprising:
a transfer printing device including a guide unit configured to introduce a multifunctional mat and transfer paper, a first heating panel configured to include an aluminum heater panel so that transfer printing of the multifunctional mat can be performed, a first manifold configured to distribute heat provided from the first heating panel, a transfer means disposed below the first manifold and configured to perform transfer printing on the multifunctional mat through thermal bonding without pressure, and a first elevation means configured to selectively elevate and lower the transfer means; and
a processing device including a mat seating part configured such that the multifunctional mat transfer-printed via the printing device is seated thereon and a processing panel having various purposes attached above the mat seating part, and configured to form a shape of the multifunctional mat by forming folding grooves and edges on the multifunctional mat through thermal bonding.

2. The mat production apparatus of claim 1, wherein an aluminum electric heater groove configured to circulate the heat and an electric heater formed on an inner circumferential surface of the aluminum electric heater groove and configured to keep temperature of heat uniform are further disposed on the transfer means.

3. The mat production apparatus of claim 1, further comprising a finishing means configured to form the thermally-bonded portions and a finishing cylinder configured to support elevating and lowering operations of the finishing means.

4. The mat production apparatus of claim 1, wherein the processing part includes:
a second heating panel composed of an aluminum processing panel, including a heat circulation groove configured such that heat is circulated therethrough and an electric heater disposed in the heat circulation groove, and configured to provide predetermined;
a second manifold configured to prevent the heat from being lost and to also distribute the heat;
a processing part configured to provide predetermined pressing force so that folding grooves and edges can be formed on the multifunctional mat;
a second elevation means configured to selectively elevate and lower the groove processing part; and
a processing panel detachably coupled below the groove processing part, and configured to form folding grooves and edges on the multifunctional mat at predetermined pressing force.

5. A multifunctional mat produced by a mat production apparatus including a printing device configured to perform printing on an upper mat made of three-dimensional space fabric and a processing device configured to form folding grooves and edges, the multifunctional mat comprising:
an upper mat made of three-dimensional space fabric and simultaneously connected and woven using pile yarn in a space between a plurality of surface fabrics;
a lower mat configured such that a member cover configured to enable functional members including cypress wood, germanium, and red clay to be contained in separate spaces according to their types is disposed and seams configured to divide the member cover so that the functional members can be separately contained are formed; and
an attachment means, such as a zipper, Velcro tape, or the like, disposed on the upper mat or lower mat, and configured to enable selective attachment and detachment according to a purpose of the multifunctional mat.

6. The multifunctional mat of claim 5, wherein a slip prevention means configured to have predetermined adhesive force is further disposed on a bottom surface of the lower mat in order to prevent the multifunctional mat from slipping.

7. A multifunctional mat production method using mat production apparatus including three-dimensional a printing device configured to perform printing on an upper mat made of space fabric and a processing device configured to form folding grooves and edges, the multifunctional mat production method comprising:
(a) a fabric introduction step of introducing transfer paper and space fabric into the printing device;
(b) a printing step of, after the step (a) has been completed, performing transfer printing of an image, such as a pattern, a character, a logo, and/or the like, on a top surface of a multifunctional mat without pressure while applying predetermined heat to the transfer paper;
(c) a mat conveyance step of, after the step (b) has been completed, moving the transfer-printed multifunctional mat to the processing device; and
(d) a thermal bonding step of forming folding grooves and edges by performing thermal bonding on a surface of the multifunctional mat, moved via the mat conveyance step, at a temperature of 250 to 300° C. for 2 to 3 minutes.
